(19) United States
(12) Patent Application Publication
(10) Pub. No.: US 2015/0328819 A1
(43) Pub. Date: Nov. 19, 2015

(54) LINER-BASED SHIPPING AND DISPENSING SYSTEMS

(71) Applicant: Advanced Technology Materials, Inc., Billerica, MA (US)

(72) Inventors: Glenn M. TOM, Bloomington, MN (US); Greg NELSON, Minneapolis, MN (US); Wei LIU, Eden Prairie, MN (US); Amy KOLAND, Eden Prairie, MN (US); Donald D. WARE, Woodbury, MN (US); Alfredo D. BOTET, Avon, CT (US); Jordon H. HODGES, Cedar Park, TX (US); Eric J. BRUNELLA, Sylvania, OH (US); Chantel ORTEGA, Millbury, OH (US); Daniel J. DURHAM, Toledo, OH (US); Tracy M. MOMANY, Sylvania, OH (US); Thomas J. Carros, Holland, OH (US)

(21) Appl. No.: 14/811,420

(22) Filed: Jul. 28, 2015

Related U.S. Application Data
(63) Continuation of application No. 14/368,124, filed on Jun. 23, 2014.
(60) Provisional application No. 61/703,996, filed on Sep. 21, 2012.
(60) Provisional application No. 61/667,723, filed on Jul. 3, 2012.
(60) Provisional application No. 61/605,011, filed on Feb. 29, 2012.
(60) Provisional application No. 61/591,393, filed on Jan. 27, 2012.
(60) Provisional application No. 61/578,683, filed on Dec. 21, 2011.

(51) Int. Cl. B29C 49/20

(52) U.S. Cl. CPC B29C 49/20; B29C 2049/2008; B29K 2067/003

(57) ABSTRACT

The present disclosure, in one embodiment, relates to a liner-based assembly having an overpack and a liner disposed within the overpack. The liner may be formed by blow molding a liner preform within the overpack to form a blow molded liner substantially conforming to the interior of the overpack and generally forming an interface with an interior of the overpack. The present disclosure, in another embodiment, relates to a liner-based assembly including a blow-molded overpack comprised of polyethylene terephthalate, a blow-molded liner disposed within the overpack, the liner comprised of a polymer material, wherein the overpack and liner have a combined wall thickness of about 0.3 mm or less, and a base cup configured to at least partially surround an exterior of the overpack. In some embodiments, the liner has a volume of up to about 4.7 liters and an empty weight of between about 260-265 grams.

### CROSS-REFERENCE TO RELATED APPLICATIONS

The present application is a continuation application of U.S. patent application Ser. No. 14/368,124, filed on Jun. 23, 2014, which is a National Phase entry of PCT Application No. PCT/US2012/070866, filed Dec. 20, 2012, which claims the benefit of U.S. Provisional Patent Application No. 61/578,683, filed Dec. 21, 2011, U.S. Provisional Patent Application No. 61/591,393, filed Jan. 27, 2012, U.S. Provisional Patent Application No. 61/605,011, filed Feb. 29, 2012, U.S. Provisional Patent Application No. 61/667,723, filed Jul. 3, 2012, and U.S. Provisional Patent Application No. 61/703,996, filed Sep. 21, 2012, the disclosures of which are hereby fully incorporated by reference in their entirety.

### FIELD OF THE INVENTION

The present disclosure relates to novel and advantageous shipping and dispensing systems. More particularly, the present disclosure relates to liner-based storage, shipping and dispense systems that include a liner disposed within an overpack, and in some cases a chime or base cup may provide support for the liner and overpack.

### BACKGROUND OF THE INVENTION

Container systems may be used in many industries for storing, shipping and/or dispensing materials of any viscosity. For example, numerous manufacturing processes require the use of ultrapure liquids, such as acids, solvents, bases, photoresists, slurries, cleaning formulations, dopants, inorganic, organic, metalorganic and biological solutions, pharmaceuticals, and radioactive chemicals. Such applications require that the number and size of particles in the ultrapure liquids be minimized. In particular, because ultrapure liquids are used in many aspects of the microelectronic manufacturing process, semiconductor manufacturers have established strict particle concentration specifications for process chemicals and chemical-handling equipment. Such specifications are needed because, should the liquids used during the manufacturing process contain high levels of particles or bubbles, the particles or bubbles may be deposited on solid surfaces of the silicon. This can, in turn, lead to product failure and reduced quality and reliability.

Typically, a shipping and dispensing system will include a container of some kind, and/or a liner, a cap that may be used to seal and protect the contents of the storage system when the contents are not being dispensed, and a connector that may be used to dispense the contents from the container. In some industries, one or more predominant dispense systems may exist, such that in order for a container system to be compatible with an end-user's existing dispense system, the container should have compatibly sized and shaped features. However, traditional storage and dispense container systems that may be compatible with such dispense systems can have one or more disadvantages. For example, traditional storage and dispense container systems may not ensure and/or maintain the purity of the contents of the container; may not efficiently use storage and/or shipping space, and therefore may result in unnecessary cost; and/or may not have satisfactory dispense rates, for example. Accordingly, there is a need for a storage and dispense system that is better than traditional storage and dispense systems in one or more ways and overcomes or reduces the effects of the disadvantages provided above.

### BRIEF SUMMARY OF THE INVENTION

The present disclosure, in one embodiment, relates to a liner-based assembly having an overpack and a liner disposed within the overpack. The liner may be formed by blow molding a liner preform within the overpack to form a blow molded liner substantially conforming to the interior of the overpack and generally forming an interface with an interior of the overpack. The overpack may be manufactured by an extrusion, stamping, or punching process, or by blow molding. In some embodiments, the overpack may be composed of a metal. In particular embodiments, the liner may be blow molded within the overpack while the overpack is still cooling from its own blow molding process. For improved performance, the overpack may be absent any bottom vent.

The present disclosure, in another embodiment, relates to a method for pressurizing a liner-based assembly for transportation and/or handling, wherein the liner-based assembly includes an overpack and a liner positioned within the overpack. The method may include pressurizing an interior of the liner to a first pressure, P1, and an annular space between the liner and the overpack to a second pressure, P2, such that a resulting pressure relationship is: P1>P2>an ambient pressure external to the overpack. In particular embodiments, the pressurizing is performed by at least partially filling the interior of the liner with a gas at a first temperature, T1, such that a resulting temperature relationship generally immediately after filling is: T1<a temperature of gas in the annular space<an ambient temperature external to the overpack, and then sealing the liner and overpack. The gas within the interior of the liner may then be permitted to warm toward the ambient temperature, thereby increasing the pressures within the liner and the annular space.

The present disclosure, in yet another embodiment, relates to a liner-based assembly including an overpack, a liner disposed within the overpack, and a substantially rectangular box of corrugated material having an opening at one end and an interior dimensioned to receive the overpack. The box of corrugated material may include a reinforcing element providing support and/or stability within the box for the overpack. The box of corrugated material may also include a handle opening on at least one side thereof.

The present disclosure, in still another embodiment, relates to a method for detecting when a collapsible liner of a liner-based assembly nears empty during pressure dispense of the contents of the liner. The method may include controlling introduction of an inlet pressure gas by the alternate switching of a control valve between an activated and non-activated setting, the inlet pressure gas being introduced in an annular space between an overpack and the liner when the control valve is activated. The method may also include monitoring the amount of time the control valve is activated between periods of non-activation and determining when the liner is near empty based on the amount of time the control valve is activated.

The present disclosure, in a further embodiment, also relates to a method for detecting when a collapsible liner of a liner-based assembly nears empty during pressure dispense of the contents of the liner. The method similarly includes controlling introduction of an inlet pressure gas by the alternate switching of a control valve between an activated and non-activated setting, the inlet pressure gas being introduced in an annular space between an overpack and the liner when the control valve is activated. The method may also include monitoring the frequency of the control valve activation and determining when the liner is near empty based on the frequency of the control valve activation.

The present disclosure, in still a further embodiment, relates to a liner-based assembly including a blow-molded overpack comprised of polyethylene terephthalate, a blow-molded liner disposed within the overpack, the liner comprised of a polymer material, wherein the overpack and liner have a combined wall thickness of about 0.3 mm or less, and a base cup configured to at least partially surround an exterior of the overpack. The overpack and/or the liner may be blow-molded with one or more panels of generally rectangular shape molded into a wall thereof. In some embodiments, the liner has a volume of up to about 4.7 liters and an empty weight of between about 260-265 grams. The liner, overpack, and/or base cup may include a UV protectant selected such that the liner-based assembly has less than 1% light transmittance in a wavelength range of about 190-425 nm. The overpack may be manufactured from a non-hazardous material and be recyclable and the liner may be incineratable. In additional embodiments, the liner-based assembly may also include a liner collar configured to fit substantially around a neck of the liner to maintain the position of the liner at a specified vertical position with respect to a mouth of the overpack. The liner collar may include a feature to prevent rotation of the liner within the overpack. The liner-based assembly may also include a cap, which may be configured for coupling with the overpack and/or the liner for sealing the contents of the liner therein. The cap may include a teartab, which may be removed permitting access to the liner. The cap may further include a breakseal that is configured to be pierced, removed, or punctured permitting access to the interior of the liner. In some embodiments, The cap may have misconnect prevention means for preventing misconnection between the cap and a dispense connector.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 is a cross-sectional view of a shipping and dispensing system according to one embodiment of the present disclosure.

FIG. 2A is a perspective view of a shipping and dispensing system according to another embodiment of the present disclosure with a base cup illustrated in partial cross-section.

FIG. 2B is an expanded view of a liner/overpack and base cup according to an embodiment of the present disclosure.

FIG. 3A is a perspective view of an overpack and an overpack with a liner preform positioned therein of an embodiment of a shipping and dispensing system of the present disclosure.

FIG. 3B is an expanded view of a two-piece overpack and a liner positioned therein of an embodiment of a shipping and dispensing system of the present disclosure.

FIGS. 3C and 3D are perspective views of a portion of a collar according to one embodiment of the present disclosure.

FIG. 3E is a perspective view of a retaining ring according to one embodiment of the present disclosure.

FIG. 3F is a perspective view of perspective view of a vented cap according to one embodiment of the present disclosure.

FIG. 3G is a perspective view of a two part overpack according to one embodiment of the present disclosure.

FIG. 3H is a perspective view of the bottom portion of a two part overpack according to one embodiment of the present disclosure.

FIG. 3I is a cross-sectional view of the top portion of an overpack coupled to the bottom portion of an overpack according to one embodiment of the present disclosure.

FIG. 3J is an exploded view a liner-based system according to one embodiment of the present disclosure.

FIG. 4 is a cross-sectional view of a shipping and dispensing system including a packaging element according to one embodiment of the present disclosure that.

FIG. 5 shows a shipping and storage system for use with indirect pressure dispense according to one embodiment of the present disclosure.

FIG. 6 shows statistics of control valve activation related to the indirect pressure dispense method shown in FIG. 5 provided in graphical form in accordance with one embodiment of the present disclosure.

FIGS. 7A-C include various views of a liner preform in accordance with one embodiment of the present disclosure.

FIG. 8 is a top view of an overpack and liner illustrating air channels between the overpack and liner in accordance with one embodiment of the present disclosure.

FIG. 9 includes perspective views of a liner and overpack system in accordance with one embodiment of the present disclosure and a traditional glass bottle of similar form factor.

FIG. 10 shows two shipping and dispensing caps in accordance with embodiments of the present disclosure.

### DETAILED DESCRIPTION

The present disclosure relates to novel and advantageous storage, shipping and dispensing systems. Examples of some of the types of materials that may be stored, shipped, and/or dispensed using embodiments of the present disclosure include, but are not limited to: ultrapure liquids, such as acids, solvents, bases, photoresists, slurries, detergents, cleaning formulations, dopants, inorganic, organic, metalorganics, TEOS, and biological solutions, DNA and RNA solvents and reagents, pharmaceuticals, printable electronics inorganic and organic materials, lithium ion or other battery type electrolytes, nanomaterials (including for example, fullerenes, inorganic nanoparticles, sol-gels, and other ceramics), and radioactive chemicals; pesticides/fertilizers; paints/glosses/solvents/coating-materials etc.; adhesives; power washing fluids; lubricants for use in the automobile or aviation industry, for example; food products, such as but not limited to, condiments, cooking oils, and soft drinks, for example; reagents or other materials for use in the biomedical or research industry; hazardous materials used by the military, for example; polyurethanes; agrochemicals; industrial chemicals; cosmetic chemicals; petroleum and lubricants; sealants; health and oral hygiene products and toiletry products; or any other material that may be dispensed by pressure dispense, for example. Materials that may be used with embodiments of the present disclosure may have any viscosity, including high viscosity and low viscosity fluids. Those skilled in the art will recognize the benefits of the disclosed embodiments, and therefore will recognize the suitability of the disclosed embodiments to various industries and for the transportation and dispense of various products. In some embodiments, the storage, shipping, and dispensing systems may be particularly useful in industries relating to the manufacture of semiconductors, flat panel displays, LEDs, and solar panels; industries involving the application of adhesives and polyamides; industries utilizing photolithography technology; or any other critical material delivery application. However, the various embodiments disclosed herein may be used in any suitable industry or application.

The liner-based systems of the present disclosure may hold up to approximately 200 liters, in some embodiments. Alternatively, the liner-based systems may hold up to approximately 20 liters. Alternatively, the liner-based systems may hold approximately 1 to 5 liters, or less. It will be appreciated that the referenced container sizes are examples only and that the liner-based systems of the present disclosure may be readily adapted for use with a wide variety of sized and shaped shipping and dispensing containers. The entire liner-based system of the present disclosure may be used a single-time and then disposed of, in some embodiments. In other embodiments, the overpack, for example, may be reused while the liner and/or any closures or connectors may be used only a single time. In still other embodiments, some portion of the closure and/or connector may be configured for a one-time use while other portions of the closure and/or connector may be configured for repeated use.

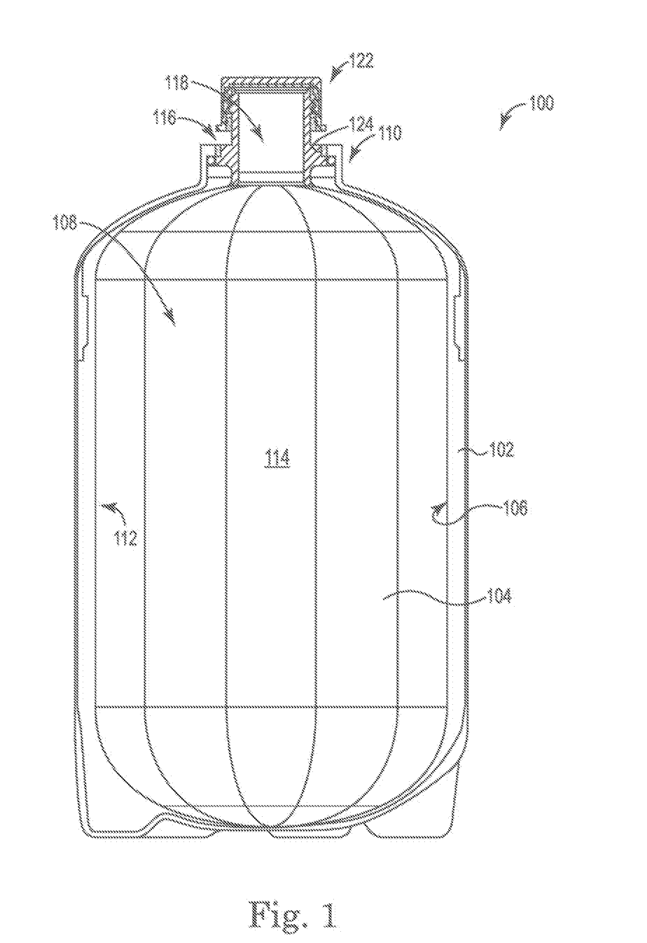

FIG. 1 illustrates one embodiment of a liner-based shipping and dispense system 100 of the present disclosure. In some embodiments, the shipping and dispense system 100 may include an overpack 102, a liner 104, and one or more closures and/or connectors 122.

The overpack 102 may include an overpack wall 106, an interior cavity 108, and a mouth 110. The overpack 102 may be comprised of any suitable material or combination of materials, for example but not limited to, metal materials, or one or more polymers, including plastics, nylons, EVOH, polyesters, polyolefins, or other natural or synthetic polymers. In further embodiments, the overpack 102 may be manufactured using polyethylene terephthalate (PET), polyethylene naphthalate (PEN), poly(butylene 2,6-naphthalate) (PBN), polyethylene (PE), linear low-density polyethylene (LLDPE), low-density polyethylene (LDPE), medium-density polyethylene (MDPE), high-density polyethylene (HDPE), polypropylene (PP), and/or a fluoropolymer, such as but not limited to, polychlorotrifluoroethylene (PCTFE), polytetrafluoroethylene (PTFE), fluorinated ethylene propylene (FEP), and perfluoroalkoxy (PFA). The overpack 102 may be of any suitable shape or configuration, such as, but not limited to, a bottle, a can, a drum, etc.

As described above, the shipping and dispense system 100 may include a liner 104, which may be disposed within the overpack 102. The liner 104 may include a liner wall 112, an interior cavity 114, and a mouth 116. The mouth 116 of the liner 104 may include a fitment portion 118. The fitment portion 118 may be made of a different material than the rest of the liner 104 and may be harder, more resilient, and/or less flexible than the rest of the liner. The fitment portion 118 may couple with a closure, connector or closure/connector combination 122 by any suitable means, such as but not limited to, complementary threading, snap-fit or friction-fit means, bayonet means, or any other suitable mechanism or combination of mechanisms for coupling, as will be appreciated by those skilled in the art. In some embodiments, a connector or closure/connector 122 may couple to, or may also couple to, the mouth 110 of the overpack 102.

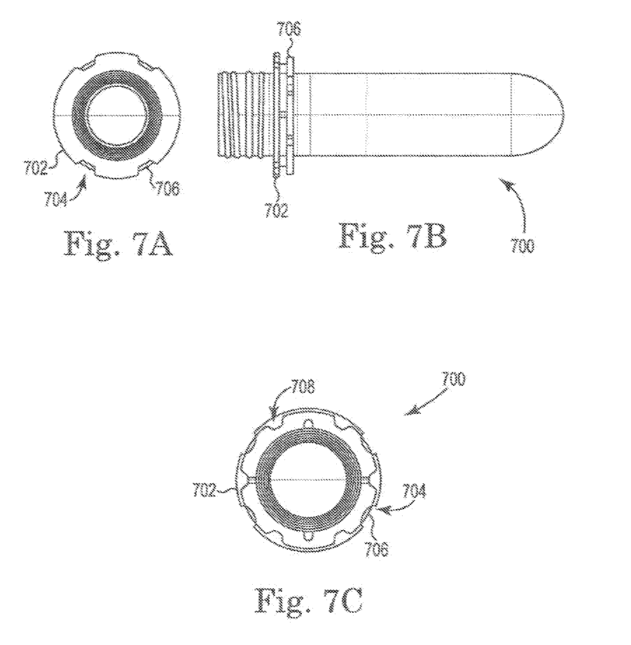

In some embodiments, a seal may be created between the necks of the liner 104 and overpack 102 with a sealing mechanism, such as a sealing ring 124 or O-ring, in order to create an enclosed annular space between the overpack and liner. Despite the seal formed between the overpack 102 and liner 104, in some embodiments, as shown in FIGS. 7A-C, which illustrate the liner preform 700 prior to being blow-molded into its finished liner state, one or more air passages may be provided in one or more neck support rings of the liner that permit gas or air from an external environment to pass through the seal between the liner and overpack and into the annular space between the overpack and liner to permit indirect pressure dispense, as will be discussed in further detail below. For example, in one embodiment, a first support ring 702 may have one or more notches or air passages 704 permitting air flow through the first support ring from an external environment. In one embodiment, the air passages 704 may be circumferentially disposed on the first support ring 702 and may be generally pyramidal, rectangular, quadrilateral, or polygonal in shape, as shown, or they may have any other suitable or desirable shape. Although not required, in one embodiment, the first support ring 702 may include one or more spaced apart, relatively shallow air passages 704, which due to their shallowness may aid in the reduction of undesirable or unintended deformation at the neck area of the liner during blow mold processing. Undesirable or unintended deformation at the neck can negatively affect the seal created between the liner 104 and overpack 102 formed by sealing ring 124. In some embodiments, the air passages 704 may allow gas or air to flow from the environment of the outer neck area of the overpack 102 into an area between the first support ring 702 and a second support ring 706. As illustrated in FIG. 7C, which is a bottom view of the liner preform 700 better illustrating the second support ring 706, the second support ring may also comprise one or more notches or air passages 708. The air passages 708 may similarly be circumferentially disposed on the second support ring 706 and may be generally pyramidal, rectangular, quadrilateral, or polygonal in shape, as shown, or they may have any other suitable or desirable shape. The air passages 708 in the second support ring 706 may allow gas or air to flow from the area between the first support ring 702 and the second support ring into the annular space between the liner 104 and overpack 102. As shown in FIG. 7C, the air passages 704 in the first support ring 702 may be configured so as not to directly align with the air passages 708 in the second support ring 706; however, such arrangement is not required and the air passages 704, 708 could be aligned in other embodiments. The one or more support rings may be comprised of any suitable material and may be formed in any suitable way, including being integral with the liner neck in some embodiments, or being affixed, welded, or otherwise coupled to the liner in other embodiments.

In some embodiments, the liner 104 may be a collapsible liner that is substantially flexible, while in other embodiments the liner may be somewhat rigid but still collapsible, e.g., a rigid or substantially rigid collapsible liner. As used herein, the terms “rigid” or “substantially rigid,” in addition to any standard dictionary definitions, are meant to also include the characteristic of an object or material to substantially hold its shape and/or volume when in an environment of a first pressure, but wherein the shape and/or volume may be altered in an environment of increased or decreased pressure. The amount of increased or decreased pressure needed to alter the shape and/or volume of the object or material may depend on the application desired for the material or object and may vary from application to application. In addition, the term “substantially rigid” is meant to include the characteristic of an object or material to substantially hold its shape and/or volume, but upon application of such increased or decreased pressure, tend to give, such as by but not limited to, flexing, bending, etc., rather than breaking

The liner 104 may be manufactured using any suitable material or combination of materials, such as but not limited to, any of the non-metal materials or combination of materials listed above with respect to the overpack 102. However, the overpack 102 and liner 104 need not be manufactured from the same materials. In some embodiments, the material or materials selected and the thickness of that material or those materials may determine the rigidity of the liner 104. The liner 104 may have one or more layers and may have any desirable thickness. In one embodiment, for example, a liner 104 may have a thickness of from about 0.05 mm to about 3 mm.

The liner 104 may be configured to comprise any desirable shape that is appealing to the user, and/or assists in the collapse of the liner. The liner 104, in some embodiments, may be dimensioned and shaped to substantially conform to the interior of the overpack 102. As such, the liner 102 may have a relatively simplistic design with a generally smooth outer surface, or the liner may have a relatively complicated design including, for example but not limited to, indentations and/or protrusions. In some embodiments, the liner wall 112 may include a generally textured surface in order to minimize adhesion. For example, in some embodiments, the surface may include a plurality of bumps, scales, or projections, which may each have any appropriate size, for example, but not limited to, from about 0.5-100 .mu.m. Texturizing features may be spaced any suitable distance from one another. In some embodiments, the texturizing may comprise a framework, such as a lattice or scaffold, for example. Examples of some suitable texturizing features are described in greater detail in U.S. Provisional Patent Appln. No. 61/334,006, titled, “Fluid Processing Components with Textured Surface for Decreased Adhesion and Related Methods,” filed May 12, 2010, which is hereby incorporated by reference herein in its entirety. The liner 104 may have a relatively thin liner wall 112, as compared to the thickness of the overpack wall 106. In some embodiments, the liner 102 may be flexible such that the liner wall 112 may be readily collapsed, such as by vacuum through the mouth 116 or by pressure between the liner wall 112 and overpack wall 106, referred to herein as the annular space therebetween.

The liner 104, in a further embodiment, may have a shape, when inflated or filled, that is different from, but complimentary with, the shape of the overpack 102 such that it may be disposed therein. In some embodiments, the liner 104 may be removably attached to the interior of the overpack wall 102. The liner 104 may provide a barrier, such as a gas barrier, against drive gas migration from the annular space between the liner wall 112 and the overpack wall 106. Accordingly, the liner 104 may generally ensure and/or maintain the purity of the contents within the liner to within at least a predetermined and acceptable tolerance.

In some embodiments, particularly where sterility of the contents of the liner must be substantially maintained, the liner 104 may be comprised of a material that may help ensure or maintain a sterile environment for the contents disposed in the liner. For example, in some embodiments the liner may be comprised of TK8 manufactured by ATMI of Danbury, Conn., or any other suitable material. Further, in some cases not only may the liner be comprised of a material that helps ensure a sterile environment for the contents of the liner, but the manufacturing process itself may, or may also, be a substantially particle and/or contamination free process. For example, the process for making a liner material, caps, closures, dip tubes, and/or any other part of a liner-based system may be made from processes that are substantially particle and/or contamination free processes. In other embodiments, in order to ensure that the liner is substantially free of contamination, one or more of the components of a liner-based system may be, or may also be, individually and thoroughly cleaned and/or sterilized prior to use to remove any particles or contaminants. As noted above, in some embodiments, the liner 104 may comprise multiple layers. The multiple layers may comprise one or more different polymers or other suitable materials. In some embodiments, the thickness, ply, and/or the composition of the liner and/or the layers of the liner may allow for the secure and substantially uncontaminated shipment of the contents of the liner-based system of the present disclosure by limiting or eliminating typical weaknesses or problems associated with traditional liners or packages, such as, for example weld tears, pin holes, gas entrainment, and/or any other means of contamination. Similarly, or in addition, the liner 104 may also contribute to the secure and substantially uncontaminated shipment of the contents of the shipping and dispense system 100 of the present disclosure by configuring the liner to substantially conform to the shape of the overpack when the liner is filled, thereby reducing the amount of movement of the contents during shipping. The overpack 102 and liner 104 may each be manufactured using any suitable manufacturing process, such as but not limited to, injection blow molding, injection stretch blow molding, extrusion, etc., and may each be manufactured as a single component or may be a combination of multiple components. In some embodiments, the overpack 102 and liner 104 may be blow molded in a nested fashion, also referred to herein as co-blow molded. Examples of liner-based systems and methods utilizing co-blow molding techniques have been described in greater detail in International PCT Appl. No. PCT/US11/55560, titled, “Nested Blow Molded Liner and Overpack and Methods of Making Same,” filed Oct. 10, 2011, which is hereby incorporated herein by reference in its entirety. In some embodiments a liner may be blow molded into an already formed overpack, whereby the overpack may function as the mold for the liner, and may be referred to herein as “dual blow molding,” which is described in further detail below. In such embodiments, the overpack may be manufactured by any suitable process.

In some embodiments, the liner-based system may include one or more handles, which may be operably or integrally attached with the liner and/or overpack. The one or more handles can be of any shape or size, and may be located at any suitable position on the dispensers. Types of handles can include, but are not limited to, handles that are located at the top and/or sides; are ergonomic; are removable or detachable; are molded into the dispensers or are provided after fabrication of the dispensers (such as by, for example, snap fit, adhesive, riveting, screwed on, bayonet-fit, etc.); etc. Different handles and/or handling options can be provided and may depend on, for example but not limited to, the anticipated contents of the dispensers, the application for the dispensers, the size and shape of the dispensers, the anticipated dispensing system for the dispensers, etc. A handle may provide means for more easily lifting or transporting the overpack and/or liner.

In some embodiments, the liner-based shipping and dispensing systems of the present disclosure may include baffles, baffling features, or other discontinuities in the interior surface(s) thereof to retard settling of the suspended solids contained therein during storage and/or transportation.

The liner-based shipping and dispensing systems described herein may be configured as any suitable shape, including but not limited to square, rectangular, triangular or pyramidal, cylindrical, or any other suitable polygon or other shape. Certain shaped or differently shaped dispensers can improve packing density during storage and/or transportation, and may reduce overall transportation costs. Additionally, differently shaped dispensers can be used to differentiate dispensers from one another, such as to provide an indicator of the contents provided within the dispensers or to identify for which application or applications the contents are to be used, etc. In still further embodiments, the dispensers described herein may be configured as any suitable shape in order to “retrofit” the dispensers with existing dispense assemblies or dispense systems.

Further examples and embodiments of the type of liners and overpacks that may be used are disclosed in more detail in: International PCT Appl. No. PCT/US11/55558, titled, “Substantially Rigid Collapsible Liner, Container and/or Liner for Replacing Glass Bottles, and Enhanced Flexible Liners,” filed Oct. 10, 2011; International PCT Appl. No. PCT/US11/55560, titled, “Nested Blow Molded Liner and Overpack and Methods of Making Same,” filed Oct. 10, 2011; International PCT Appl. No. PCT/US11/64141, titled “Generally Cylindrically-Shaped Liner for Use in Pressure Dispense Systems and Methods of Manufacturing the Same,” filed Dec. 9, 2011; U.S. Prov. Appl. No. 61/468,832, titled “Liner-Based Dispenser,” filed Mar. 29, 2011; U.S. Prov. Appl. No. 61/525,540, titled “Liner-Based Dispensing Systems,” filed Aug. 19, 2011; U.S. patent application Ser. No. 11/915,996, titled “Fluid Storage and Dispensing Systems and Processes,” filed Jun. 5, 2006; International PCT Appl. No. PCT/US10/51786, titled “Material Storage and Dispensing System and Method With Degassing Assembly,” filed Oct. 7, 2010, International PCT Appl. No. PCT/US10/41629, U.S. Pat. No. 7,335,721, U.S. patent application Ser. No. 11/912,629, U.S. patent application Ser. No. 12/302,287, and International PCT Appl. No. PCT/US08/85264, each of which is hereby incorporated by reference herein in its entirety. The overpack 102 and liner 104 for use with the shipping and dispense system 100 of the present disclosure may include any of the embodiments, features, and/or enhancements disclosed in any of the above noted applications, including, but not limited to, flexible, rigid collapsible, 2-dimensional, 3-dimensional, welded, molded, gusseted, and/or non-gusseted liners, and/or liners that contain folds and/or liners that comprise methods for limiting or eliminating choke-off and liners sold under the brand name NOWpak® by ATMI, Inc. for example. Various features of dispensing systems disclosed in embodiments described herein may be used in combination with one or more other features described with regard to other embodiments.

The various embodiments of storage and dispense systems described herein may be utilized in any suitable dispense processes. For example, the various embodiments of storage and dispense system described herein may be utilized in pressure dispense processes, including direct and indirect pressure dispense, pump dispense, and pressure-assisted pump dispense, including various embodiments of inverted dispense methods disclosed in Korean patent registration no. 10-0973707, titled “Apparatus for Supplying Fluid,” which is hereby incorporated by reference herein in its entirety. Similarly, the various embodiments of storage and dispense system described herein may be utilized in traditional manual or automatic pour methods. As will be appreciated, the storage and dispense systems permit indirect pressure dispense for a variety of delivery applications for which indirect pressure dispense was traditionally unavailable, and can reduce defects and yield losses associated with traditional pump and vacuum delivery systems.

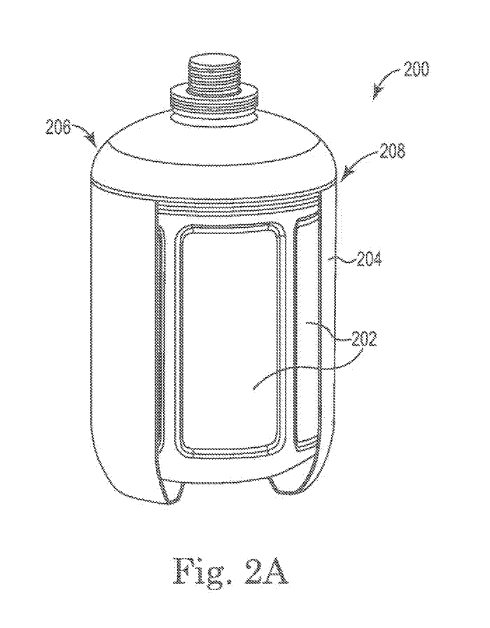

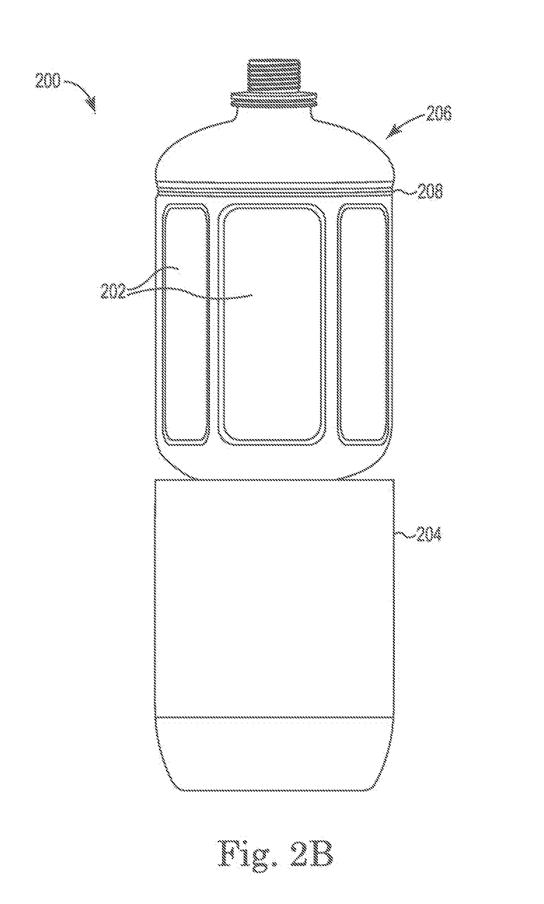

In one particular embodiment, as illustrated in FIGS. 2A and 2B, a storage and dispense system of the present disclosure may include a liner-based system 200 having a liner positioned within an overpack 206. The liner and overpack may each be formed by blow molding, such as but not limited to nested co-blow molding or dual blow molding, as indicated above. The liner and/or overpack may include surface features, and in some embodiments, such as where nested co-blow molding is used to manufacture the liner and overpack, co-extensive surface features that may help minimize or eliminate dimpling in the liner and/or overpack that may result from temperature changes, for example. Particularly, in one embodiment, the liner and overpack may contain surface features, such as but not limited to, one or more indented or protruding panels that may be positioned around the circumference of the liner and overpack. More particularly, in one embodiment, the liner and overpack may contain surface features, such as but not limited to, one or more surface features or panels having a generally rectangular-shaped design. For example, as may be seen in FIG. 2, six generally rectangular-shaped panels 202 may be vertically disposed along the circumference of the liner and/or overpack walls; however, any other number of panels may be suitably used. The panels 202 may have a height generally equal to the non-sloping height of the liner and overpack; that is to say, for example, that the panels 202 may not cover the top portion of a liner and overpack that may begin to slope or curve toward the mouth of the liner and overpack. In some embodiments, the panels 202 may each have substantially the same size and shape as the other panels, or in other embodiments, one or more panels may be differently sized and shaped than one or more other panels. Also, the boundary edge that defines a panel 202 may have any suitable thickness and/or definition, including a shallow depth or a more defined and/or greater depth. In some embodiments, the edging depth may be generally the same for each panel and/or for the entire perimeter of a single panel, while in other embodiments the depth may vary from panel to panel or from one position along the perimeter to another position along the perimeter of the same panel. While the six-panel design is described and shown as generally rectangularly-shaped panels 202, it will be understood that any suitable or desirable geometry is contemplated and within the spirit and scope of the present disclosure. Further, it will be understood that any suitable number of panels, spaced any suitable distance from one another is contemplated and within the spirit and scope of the present disclosure. Generally, surface features such as one or more panels may add strength and/or rigidity to the liner and/or overpack. However, in some embodiments, more shallow edging may also keep the liner from sticking to the overpack.

As may also be seen in FIGS. 2A and 2B, the liner-based system 200 may, in some embodiments, include a chime or base cup 204, which may be used, for example, for additional support and/or to provide a smooth generally rigid exterior surface for the liner-based system, which can hide any dimpling effects of the liner and/or overpack created by temperature changes and/or may create a surface for labels and the like. In some embodiments, the chime 204 may extend a sufficient height to generally cover the rectangular panel surface features, while in other embodiments, the modified chime may extend any suitable lesser height, including a substantially shorter height as compared to the liner or overpack, which may add free-standing support to the liner-based system. The chime 204 may be comprised of any suitable material, including plastic, for example PET, high density polyethylene (HDPE), or any other suitable polyester, or any other suitable material or plastic, or combination thereof. The chime 204 may be relatively rigid as compared to the liner and/or overpack in some embodiments, and because the chime may generally fit over a substantial portion of the liner/overpack, if the liner/overpack collapses, dimples, or otherwise distorts, the chime may generally maintain a smooth and rigid shape. As such, any distortion of the liner/overpack may be generally unobservable from the exterior of the liner-based system. Further, the smooth exterior surface of the chime 204 may provide a generally undistorted surface for adhering a label.

The walls of the chime may have any suitable thickness. In some particular embodiments, the chime may have walls that may be from about 0.2 mm to about 0.7 mm thick. In still other embodiments, the walls may be from about 0.3 mm to about 0.6 mm thick. In still other embodiments, the walls may be about 0.5 mm thick. In some embodiments, the chime may be made by injection molding or injection blow molding processes. Though in other embodiments, the chime may be made from any other suitable process. The chime 204 may also include a colorant or other additives to protect the liner and overpack from UV light. In some embodiments the chime may be press-fit over the overpack without the need for adhesives or welding. In other embodiments, the overpack 206 may include connecting features 208 for connecting to the chime, including snap-fit, friction-fit, bayonet, or other features that allow the chime to be detachably coupled to the overpack. In still other embodiments, the chime may be adhered to the overpack with an adhesive, for example.

In one example embodiment of the present disclosure, the liner may be comprised of PEN and the overpack and chime may be comprised of PET. In another example embodiment, the liner may be comprised of a polyolefin or a polyester, while the overpack and chime may be comprised of PET. It will be understood, as described above however, that the liner, overpack, and chime disclosed herein may be comprised of any of the materials or any combination of materials discussed herein.

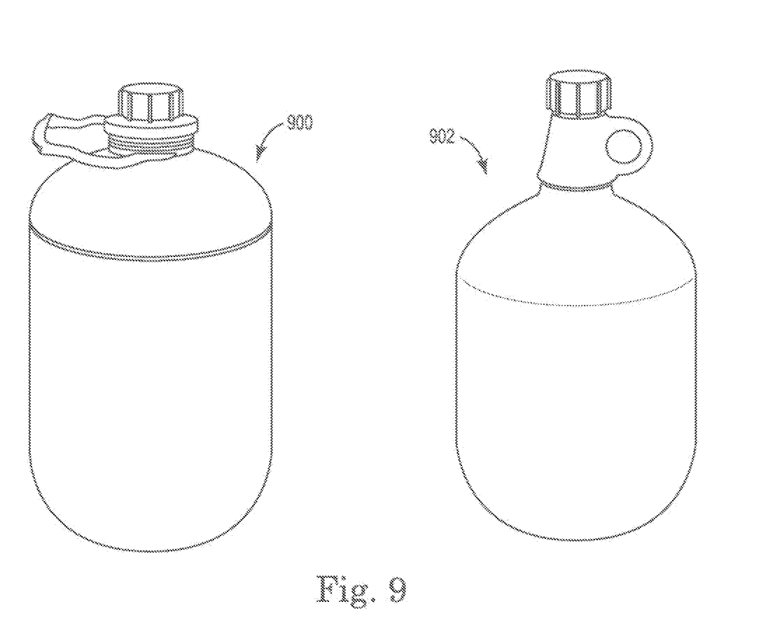

In some embodiments, the storage and dispensing systems of the present disclosure may be used as alternatives to, or replacements for, simple rigid-wall containers, such as those made of glass. Such containers can have increased overall cost when all factors are considered, including the cost of ownership, shipping, sanitizing, etc. In a particular embodiment, illustrated in FIG. 9, a liner and overpack system 900 of the present disclosure may be configured as having the same general form factor or general dimensions as that of a traditional one gallon glass bottle 902 commonly used in critical material delivery applications. In one embodiment, however, based on the inclusion of various features described herein and other design choices, the liner and overpack system 900, as illustrated, may hold about 4.7 liters, which is about a 22% increase in volume compared to the traditional glass bottle 902. Other advantages of the liner and overpack system 900 of the present disclosure over the traditional glass bottle 902 include, but are not limited to, the following:

Liner and overpack system 900 may include a non-hazard recyclable overpack and an inner liner that may be incinerated, thereby reducing waste and environmental impact compared to the traditional glass bottle 902, which often must be decontaminated and/or disposed as hazard waste.

Liner and overpack system 900, among other dispense methods, permits dispense of the contents therein by indirect pressure applied to the annular space between the liner and overpack. The traditional glass bottle 902 does not. Indirect pressure dispense, among other things, may reduce the risk of micro bubble formation.

Liner and overpack system 900 can permit increased and more consistent material utilization than that of the typical setup for a traditional glass bottle 902.

Liner and overpack system 900 is much more resistant to breakage, whereas the traditional glass bottle is fairly breakable.

Liner and overpack system 900, as illustrated in FIG. 9, at a volume of approximately 4.7 L, is significantly lighter when empty than the traditional one gallon glass bottle 902 of similar form factor when also empty.

In further applications utilizing the various embodiments of the present disclosure, a certain minimum amount of stiction between the overpack and liner, as the liner collapses away from the overpack may occur. Thus, in some embodiments of the present disclosure, one or more additional features, steps, or procedures may be provided to reduce or substantially eliminate stiction between the overpack and liner as the liner collapses away from the overpack. For example, in one embodiment, additional quality control processes may be utilized to spot check a certain number of overpacks and liners in a particular manufacturing batch to determine whether the stiction is below the specified requirements desired.

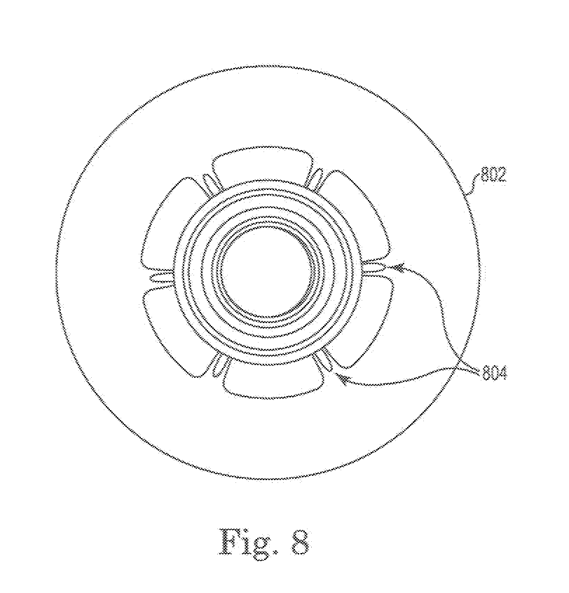

In additional embodiments of blow molded liner and overpack systems, to help reduce unintended stiction, one or more air channels, illustrated in FIG. 8, may be provided between the liner and overpack, for example near the top of the liner and overpack, to permit easier and/or more even flow of gas or air into the annular space between the liner and overpack. The air channels may be provided, such as integrally provided, on the liner or the overpack, or both. FIG. 8 shows a top view of an overpack 802 with liner positioned therein illustrating one embodiment of air channels 804 formed between the liner and overpack. In some embodiments, the air channels 804 may be formed or molded into the liner or overpack preform and may be designed to keep the liner from making complete contact with the overpack at the location of the air channels during the blow molding processes disclosed herein. The air channels 804 may allow the gas or air that can be introduced during indirect pressure dispense or pressure assisted pump dispense to flow more easily and/or more evenly throughout the annular space between the overpack and liner, thereby eliminating or reducing the occurrence of pin holes. Any number of air channels 804 may be provided, such as but not limited to, from 2-12 air channels; of course, it is recognized that any fewer or greater suitable number of air channels may be provided. Further, the air channels 804 may extend any suitable length down the side of the overpack 802, may have any suitable geometry, and may be disposed at any suitable place on the overpack. The air channels 804 may be formed from the same material as the overpack 802 in some embodiments, and may protrude from the walls of the overpack, such that the liner may be kept a certain distance from the overpack walls in the area with air channels, thereby allowing gas to flow more freely into the annular space. In some embodiments, the overpack preform may be configured to create the one or more air channels 804. For example, the air channels 804 may be formed by wedge-like protrusions made in the overpack preform, which extend during the blow molding process to create the finished air channels. In another embodiment, one or more air channels 804 may be affixed by any suitable means to the overpack 802 after the overpack is formed. In such embodiments, the air channels 804 may be comprised of the same material or any suitable different material than the overpack.

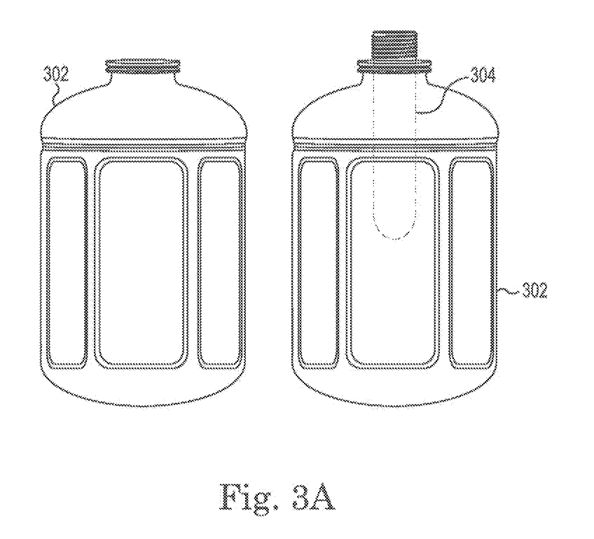

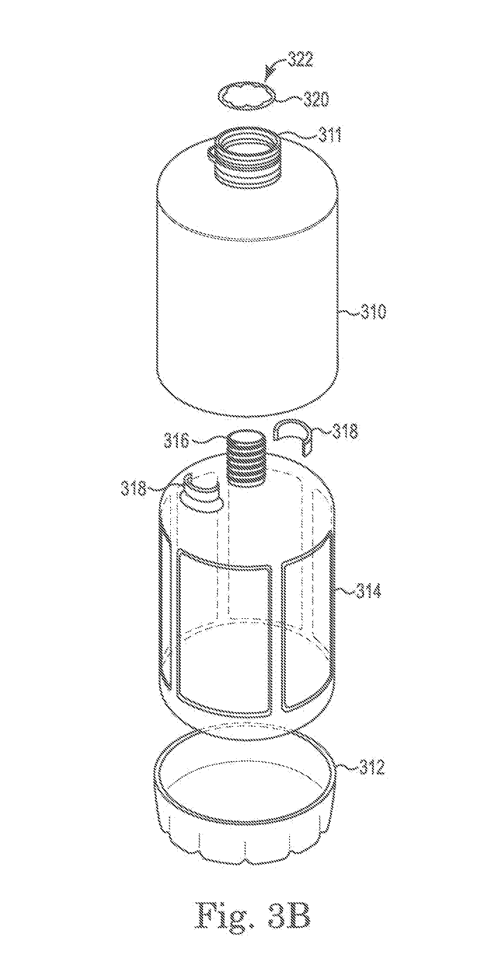

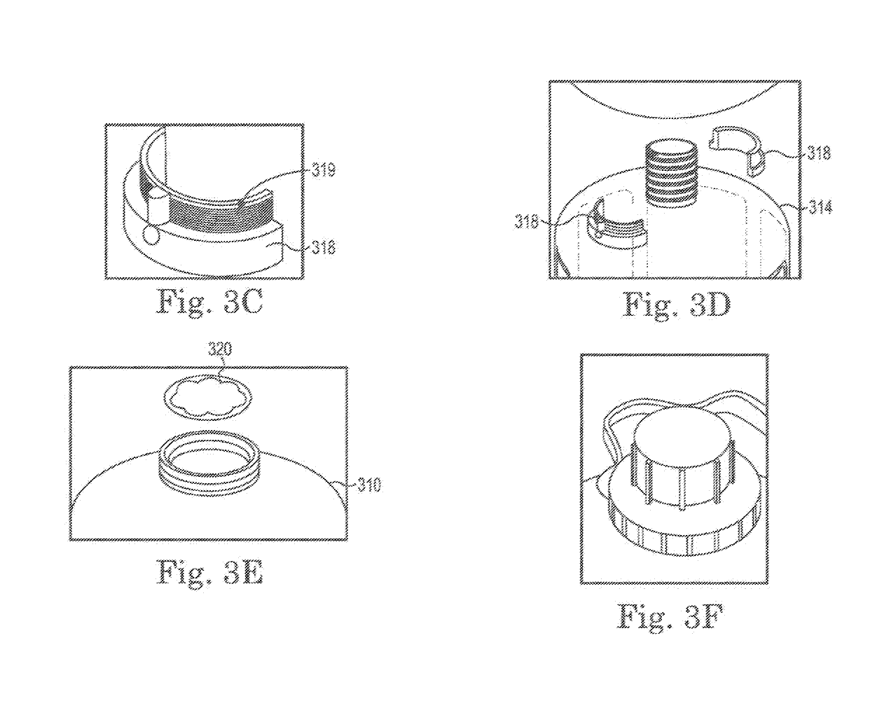

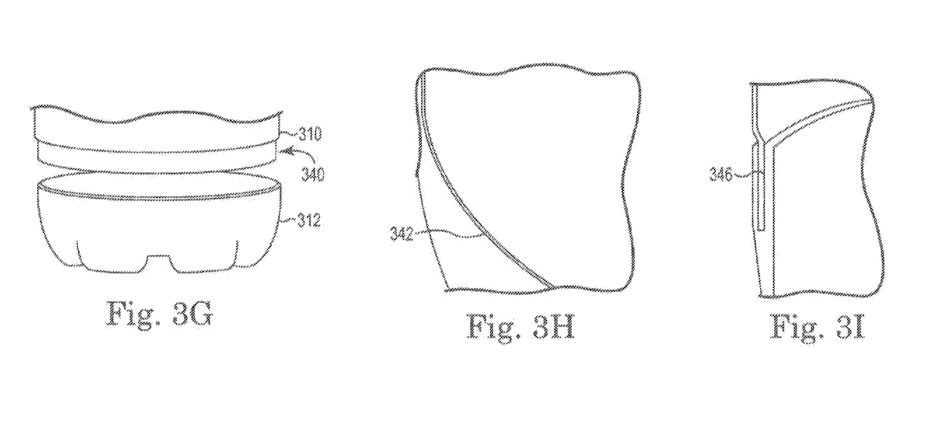

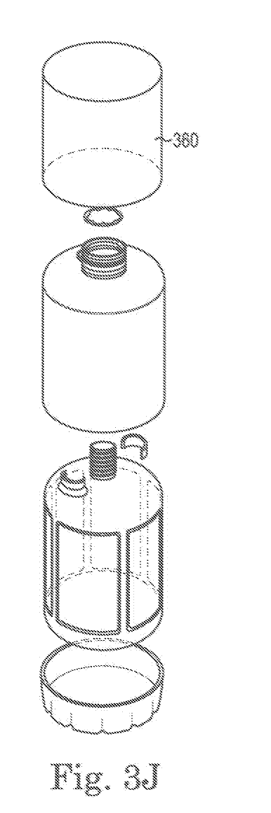

In another embodiment, as briefly mentioned above, a dual blow molding process may be utilized, as shown in FIG. 3A, in which an overpack 302 may first be blow molded from an overpack preform to predetermined size and shape specifications. Subsequently, a preform for the liner 304 may be blow molded to the interior of the overpack 302. The dual blow molding process according to some embodiments described herein generally forms an integrated system comprising an overpack and a liner, the overpack and liner generally forming an interface where the liner and overpack walls abut or otherwise interface or come proximate one another.

According to one embodiment of the present disclosure, a dual blow mold method may include forming a liner preform by injecting a molten form of a polymer, for example, into an injection cavity of a preform mold die. The mold temperature and the length of time in the mold may depend on the material or materials selected for manufacturing the liner preform. In some embodiments, multiple injection techniques may be used to form a preform having multiple layers. The injection cavity may have a shape that corresponds to a liner preform with an integral fitment port. The polymer may solidify, and the resultant liner preform may be removed from the preform mold die. In alternative embodiments, a pre-manufactured preform, including a multilayer preform, can be used for the preform of the present disclosure.

The same process as described above may be substantially followed in order to create a preform for the overpack. Although not required, in some embodiments, the preform for the overpack may generally be larger than the liner preform so that the liner preform could fit inside of the overpack preform.

Once the liner preform and the overpack preform have been created, the overpack preform may be inserted into an overpack mold having substantially a negative image of the desired completed overpack. The overpack preform may then be heated and blown, or stretched and blown in other embodiments, to substantially the image of the mold to form the overpack, as will be appreciated by those skilled in the art. The blow molding air speed, as well as the blow molding temperature and pressure, may depend on the material selected for manufacturing the overpack preform. Once blown to the image of the mold, the overpack may cool, solidify, and be removed from the mold. The overpack may be removed from the mold by any suitable method. In other embodiments, the overpack may be left in the mold until the liner is subsequently blow molded, as described below.

Subsequent blow molding of the overpack, either while the blown overpack is cooling or after the overpack has cooled completely, the liner preform may be inserted inside of the blown overpack. In some embodiments, prior to inserting the liner preform into the blown overpack, the liner preform may be heated. In some embodiments, the liner preform may be manually placed inside of the overpack preform. However, in other embodiments, it may be more desirable that the liner preform be placed inside of the blown overpack by an automated or generally automated process. The liner preform may then be heated and blown, or stretched and blown in other embodiments, to substantially the image of the blown overpack, utilizing the blown overpack as the negative mold for the liner. Again, the blow molding air speed, as well as the blow molding temperature and pressure, may depend on the material selected for manufacturing the liner preform.

In one embodiment, the material comprising the liner may be the same as the material comprising the overpack. In another embodiment, however, the material comprising the liner may be different from the material comprising the overpack. For example, in one embodiment, the liner may be comprised of PEN, while the overpack may be comprised of PET or PBN, for example. In other embodiments, the liner and overpack may be comprised of any suitable same or different materials, as described herein.

In the dual blow molding process, or any other blow molding process disclosed herein, it may be desirable and/or advantageous for the various embodiments of overpack and liner systems described herein to reduce or minimize the amount of air in the annular space between the overpack and liner. The dual blow molding process, described above, may help reduce the amount of air in the annular space due to the inherent characteristics and steps of the process, e.g., the liner preform being blow molded into the overpack while the overpack is cooling. In some embodiments, different materials for the manufacturing of the liner preform and overpack preform can also assist in reducing stiction and the amount of air space between the overpack and liner, particularly with respect to a dual blow mold process. The reduction of the amount of air in the annular space can, for example only, help increase dispensability, decrease liner movement within the overpack, such as during transportation, increase strength of the overpack/liner system, etc.

In some conventional blow molding methods, the overpack may be formed with a vent at or near the bottom, such that air may escape the bottom of the overpack during particular blow molding steps or subsequent dispense processing. According to the above-described dual blow molding process, or any other blow molding process disclosed herein, the overpack of the present disclosure need not be formed with a bottom vent, since pressure dispensing with the overpack and liner systems of the present disclosure may advantageously include pressurizing from the top of the overpack and/or liner. Additionally, not having a bottom vent advantageously avoids the need to provide a seal or plug for the vent and can increase reliability of the overpack/liner system.

In other embodiments, it is recognized that the overpack may be manufactured using any other manufacturing process, and it is not limited to being manufactured from a preform through a blow molding process. For example, a liner may be molded by blow molding the liner into a non-blow molded overpack, such as an overpack manufactured from an extrusion, stamping, or punching process, as will be recognized by those skilled in the art. The overpack may for example, be a stamped or formed metal overpack. However, the overpack could be comprised of any other suitable material or combination of materials such as wood, plastic, glass, cardboard, or any other material. Blow molding the liner into a metal overpack may provide further desirable barrier elements that may help preserve the contents of the liner. Such process may help reduce stiction between the overpack and liner as the liner collapses away from the overpack during subsequent dispense processes.

In a similar embodiment for reducing stiction, the liner may be separately formed, such as by blow molding, and subsequently collapsed and re-inflated into the molded overpack. Alternatively, the overpack and liner may be formed by nested co-blow molding, as described above, and the liner may be subsequently collapsed and re-inflated within the overpack. In yet another embodiment, the liner may be blow molded into a mold, collapsed and inserted into the overpack, and then re-inflated in the overpack. The process of collapsing and re-inflating the liner within the overpack may tend to break any bonds or areas of stiction between the liner and the overpack.

As illustrated in FIG. 3B, in one embodiment a liner-based system may include a liner 314 manufactured by any of the means described herein, a liner collar 318, an overpack top piece 310 and an overpack base cup 312, a retaining ring 320 and one or more caps, covers, closures and/or connectors. The overpack top piece 310 and base cup 312 operably couple together to form an overpack for the liner 314.

The liner collar 318, shown in FIGS. 3B, 3C and 3D, may be manufactured using any suitable process including any molding process, for example, and may be comprised of any suitable material or combination of materials, such as plastic or metal, such as any of the material listed herein. The collar 318 may fit over and around the liner neck 316, such that the collar 318 may be manually positioned to generally surround the liner neck 316. In some embodiments the collar 318 may couple to the neck of the liner by any suitable method, for example by snap fit, complementary threading, or any other suitable method. In other embodiments, the collar 318 may be positioned around the neck of the liner but may not be coupled to the liner, thereby allowing the collar 318 to move freely about the neck of the liner. The collar 318 may have coupling features 319 for coupling, such as by grooves, threading, snap-fit, friction-fit, bayonet fit, or any other suitable means for coupling, with a retaining ring, such as retaining ring 320 shown in FIGS. 3B and 3E.

The liner with the collar 318 positioned over and around the liner neck 316 may be positioned within the overpack top piece 310, such that a portion of the liner neck may extend through and beyond the mouth 311 of the overpack top piece. The retaining ring 320 may then be placed over the liner neck 316 and coupled with the collar 318. The retaining ring 320 may also be comprised of any suitable material or combination of materials including plastic, metal, or any other suitable material, such as the materials listed herein. The retaining ring 320 may also include coupling features 322, complementary with the coupling features 319 of the collar 318, for coupling with the collar. In some embodiments, for example, the retaining ring coupling features 319 may include somewhat flexible tabs that may lock into corresponding grooves of the liner collar 318. Nonetheless, other connecting features are also possible and are within the spirit and scope of the present disclosure.

The retaining ring 320 and the collar 318, when coupled together, may ensure that the liner neck 316 remains consistently positioned at substantially the desired vertical position relative the overpack mouth and/or substantially the desired annular position relative the overpack mouth. In some cases, for example, it may be desirable to maintain the liner neck 316 in a substantially vertical, substantially static position relative the overpack, as such positioning may aid in completely filling the liner, dispensing the contents of the liner, keeping out or minimizing impurities and/or minimizing the creation of bubbles in the contents of the liner. The retaining ring 320 and/or the collar 318 may further include features that aid in the prevention of rotation of the liner, if desired. Such anti-rotation features may include corresponding and complementary threading located on the retaining ring and the collar, for example. Alternatively, the anti-rotation features may include complementary bumps and grooves, or teeth and slots located on the retaining ring and collar, or any other suitable anti-rotation features may be used to keep the retaining ring and collar from rotating relative to one another, and consequently keeping the liner from being able to rotate.

The overpack top piece 310 with the liner positioned therein may then be positioned onto the base cup 312. In some embodiments, the overpack top piece 310 may couple with the base cup 312, and may couple with the base cup by any suitable means including but not limited to, snap-fit, friction-fit, bayonet connection, adhesives/sealants, welding or any other suitable means of connection or combination thereof. Complementary threading may be used or may also be used to couple the two portions of the overpack. In one embodiment, for example, as may be seen in FIG. 3G, annular threads 340 at a bottom portion of the overpack top piece 310 may couple with complementary annular threads at a top portion of the base cup 312 such that the top piece 310 may be secured to the base cup 312. An adhesive or an epoxy may additionally or alternatively be used to secure the two pieces of the overpack together. For example, in some embodiments the base cup 312 may have a bevel or groove 342 into which an edge 346 of the top piece of the overpack may be positioned, as shown in FIGS. 3H and 3I. An adhesive or an epoxy, for example, may be placed in the bevel 342 prior to positioning the edging 346 into the bevel, to further secure the overpack.

In some instances, the liner and/or the overpack may be prone to dimpling or distorting during storage and/or shipping. For example, when a liner is filled with material at a particular temperature and the liner-based system is sealed, a subsequent change in temperature may result in the material in the liner expanding or contracting thereby causing the liner and/or overpack to distort. While the liner-based system may be designed as described herein to tolerate such distortion, it may still be desirable to maintain a non-distorted, smooth exterior surface for aesthetic reasons or to allow for labels to be affixed to the overpack, for example. Accordingly, in one embodiment, a cap may include a venting feature that allows air or gas to pass into and out of the annular space between the liner and the overpack, thereby eliminating the propensity for the liner-based system to distort due to temperature change. Any cap or closure described herein or incorporated by reference herein may be so vented. The venting mechanism may be any suitable venting mechanism. In one embodiment the venting mechanism 315 may include a cap or closure equipped with a hydrophobic membrane, comprised of Gortex, for example, or any other suitable material or combination of materials. The hydrophobic membrane may generally prevent moisture from getting into the annular space and/or the membrane may help keep any vapors from the contents of the liner from escaping from the overpack and into the environment in the event of a liner leak.

In another embodiment, distortion tendencies may be addressed by including an annular or cylindrical sleeve 360 in the liner-based system, as shown in FIG. 3J. The sleeve 360 may fit substantially snuggly around the exterior of the overpack. In the event that the overpack distorts due to thermal expansion, for example, the sleeve may remain smooth and undistorted, thereby providing a smooth surface for placing labels, for example. The sleeve 360 may be comprised of any suitable material including plastic, metal or any other suitable material or combination of materials, such as those listed herein, and may be manufactured from any suitable manufacturing process, such as but not limited to molding processes.

In some similar instances, the liner and/or the overpack may be prone to denting or other deformation caused by movements or handling during storage and/or shipping. In one embodiment, generally, an overpressurizing method may be used to provide shipped packaging systems with increased buckle/denting/deformation resistance. Additionally, the overpressurizing method may decrease liner movement within the overpack, such as during transportation or handling.

More particularly, in general, various embodiments of overpack and liner packaging systems disclosed herein include three pressure regions: inside the liner; outside the overpack (or external environment); and the annular space between the liner and overpack. In one embodiment, a desired pressure relationship between these three regions during transport and/or storage may be P.sub.liner>P.sub.annular>P.sub.environment. In this respect, the liner and annular space are overpressurized with respect to the external environment. When this pressure relationship is met, dents and deformations to the liner and overpack can be reduced or minimized.

In one embodiment, in order to create this overpressurized relationship, the liner interior may be filled with a gas at a relatively lower temperature than the external environment. This may be accomplished by injecting a relatively cold or cooler gas into the liner. This may also lower the temperature of the adjacent annular space such that the T.sub.liner<T.sub.annular. Upon sealing of the overpack and liner, the gas may warm toward the temperature of the external environment and the pressures of the liner interior space and annular space will correspondingly increase according to the above pressure relationship. Generally, the temperature relationship between the three pressure regions during the conditioning, or warming, process may be T.sub.liner<T.sub.annular<T.sub.environment. The initial feed gas temperature can be calculated for specific overpack/liner systems based on a variety of factors, including but not limited to, the heat transfer coefficient and heat capacity of the liner. While any gas, or even air, could be used, it may be desirable in many cases to use a clean or inert gas, such as but not limited to, nitrogen.

The liner-based systems of the present disclosure, once filled, may be pressurized, standardly or by the methods disclosed above, and capped. In additional embodiments, the liner-based systems may be placed in a bag and/or a box or other package for storage and/or shipping. In a particular embodiment, a liner-based system may be wrapped or double-wrapped in a polyethylene bag and closed or sealed, such as with a cable tie or other sealing mechanism, including heat sealing. The wrapped liner-based system may further be positioned within a box, such as but not limited to, a corrugated fiberboard box, for transport. In some embodiments, a desiccant may be placed in the packaging to remove any unwanted moisture from the liner-based system.

In yet another embodiment, a slip agent may be added to the preform material for at least one of the liner or overpack preform, which may later be molded, including by co-blow molding, injection blow molding, extrusion blow molding, or any other suitable molding process. For example, in one embodiment, a slip agent may be added to the overpack preform. The addition of the slip agent may decrease the potential for the liner to adhere to the overpack once blow molded. The slip agent may be any suitable material, including but not limited to a PTFE-based slip agent, for example.

In another embodiment, a preform for a liner of the present disclosure may be overmolded with a material for reducing or preventing stiction between the blow molded liner and overpack. For example, a liner preform may be overmolded with EVOH or any other suitable material. The overmolding may make the exterior surface of the liner relatively slicker, thereby decreasing the potential for stiction between the liner and the overpack during subsequent dispense processes.

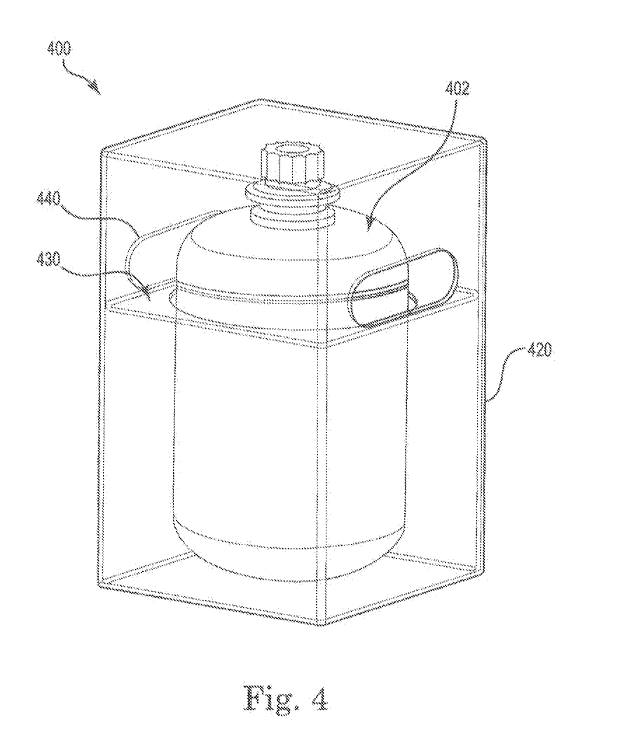

In one embodiment of the present disclosure a storage and dispense system 400 may include an additional optional packaging element 420, in which the liner and overpack 402 may be positioned. The packaging element 420 may be used to store, transport, and/or carry the liner and overpack 402, in some cases relatively easily. The packaging element 420 may generally be a box configured from a corrugated material, such as but not limited to cardboard. However, in other embodiments, the packaging element 420 may be comprised of any suitable material or combination of materials including paper, wood, metal, glass, or plastic, for example. The packaging element 420 may include one or more reinforcing elements 430 that may provide support and/or stability for the liner and overpack 402 disposed therein. A reinforcing element 430 may be positioned at any appropriate or desired height in the packaging element 420. For example, as may be seen in FIG. 4, one reinforcing element 430 may be provided near the top of the body of the overpack and liner 402. However, in other embodiments, one or more reinforcing elements may be positioned at other areas of the overpack, for example at the bottom of the overpack, or the middle of the overpack. In still another embodiment, the reinforcing element may generally fill substantially all of, or some portion of the space not taken up by the liner and overpack. The reinforcing element(s) 430 may be comprised of any suitable material or combination of materials, such as but not limited to the materials listed above for the packaging element. In some embodiments, the reinforcing element(s) 430 may be comprised of the same material as the remainder of the packaging element 420, although use of the same materials is not necessary. The packaging element 420 may also have one or more handles or handle slots/openings 440 that may make the packaging element 420 relatively easy to move and/or carry. The packaging element 420 may be any desired shape, and in some cases may be a generally rectangular box, as shown. A plurality of systems, such as those shown in FIG. 4, may be easily and conveniently packed for storage and/or shipping due to the rectangular box shape of the packaging element. Additionally, the packaging element may further protect the liner and overpack disposed therein, from exposure, such as exposure to potentially harmful UV rays.

In some embodiments including a packaging element 420, the liner and overpack system may not include a handle or chime because the storage unit 420 may provide handle slots/openings and the support otherwise provided by the chime. Accordingly, a cost associated with the liner and overpack related to the handle and/or chime may be reduced or eliminated in such embodiments. Nonetheless, in other embodiments, the liner and overpack may still include a handle and/or chime in embodiments including a packaging element.

Generally, in use, a liner-based system of the present disclosure may be initially readied for filling and/or shipped to a fill site. The liner-based system may subsequently be filled with a desired substance and may be shipped to an end-user. The liner may be filled with, or contain, for example, an ultrapure liquid, such as an acid, solvent, base, photoresist, dopant, inorganic, organic, or biological solution, pharmaceutical, or radioactive chemical. However, it is recognized that the liner may be filled with any other suitable materials, such as but not limited to the materials previously listed. The contents may be sealed under pressure, if desired, and may further be wrapped in a bag and/or box, including but not limited to the packaging element described above, to be readied for transport.

The end-user may then store and/or dispense the contents of the container. In some embodiments, a shipping/dust/temporary cap may be coupled to the liner and/or overpack. Such a cap may help ensure that contaminants are not introduced into the liner and/or overpack during shipping and/or storage. Further, the cap may help protect any other caps and/or connectors that may be coupled to the dispenser. In some embodiments, the shipping cap may be a screw-on cap, while in other embodiments, the cap may connect via snap-fit, bayonet fit, or any other suitable mechanism for coupling to the dispenser. In some embodiments, the shipping cap may be relatively inexpensive, and comprised of, for example plastic. However, in other embodiments, the cap may be comprised of any suitable material or combination of materials including rubber, or metal, for example. When it is desired to dispense the contents of the liner, the cap may be removed and the contents may be dispensed through the mouth of the liner using any suitable dispense method, such as by pressure dispense, including direct and indirect pressure dispense, pump dispense, pressure-assisted pump dispense, pouring, or any other suitable means of dispensing the contents of a container consistent with the intended use of the material, or application involved. In some embodiments, a dispense connector, configured for a particular dispense method, may be affixed to the liner-based system in preparation for dispense of the contents of the liner. The dispense connector may be configured to be compatible with particular dispense systems used by an end-user, which may vary from industry to industry.

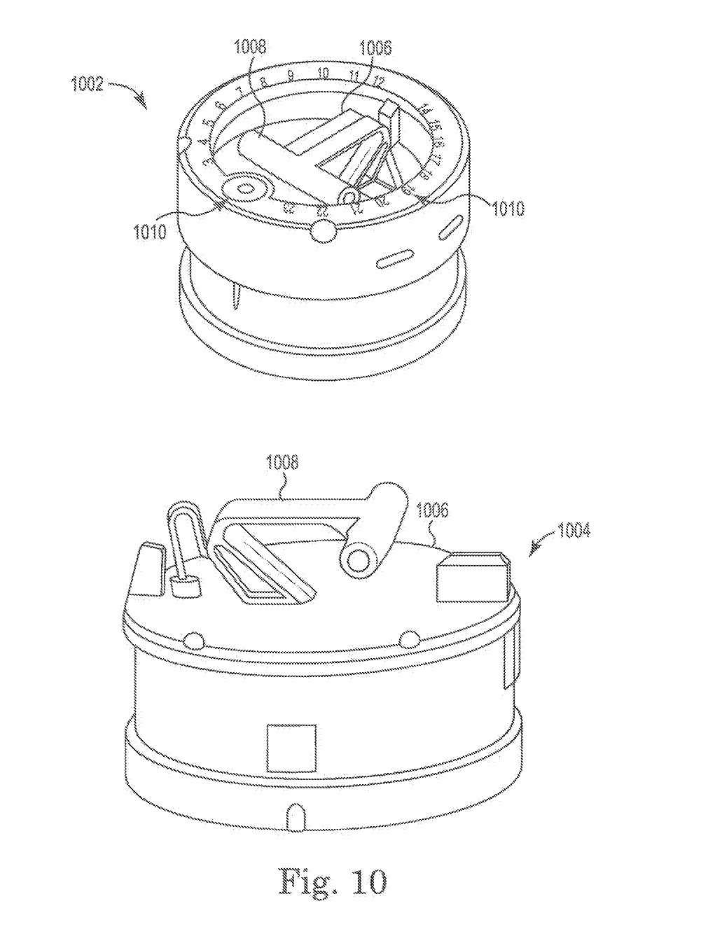

In some embodiments, a shipping and/or storage cap/closure may include features that allow it to be operably connected with an end user's dispense connector instead of being removed prior to dispense. Two such embodiments of a cap/closure 1002, 1004 are illustrated in FIG. 10. A cap/closure 1002, 1004 may include a removable teartab or cover 1006. Teartab 1006 may be generally secured to a base of the cap/closure 1002, 1004 during initial storage and shipping. When it is desirable to dispense the contents of the container, the teartab 1006 may be removed, for example, by pulling on a teartab handle 1008. With the teartab 1006 removed, the contents of the liner may be exposed and a dispense connector may be coupled with the cap/closure 1002, 1004 for dispense of the contents within the liner and overpack system. In additional embodiments, below the teartab 1006, the cap/closure may further include a breakseal, such that contaminants are substantially prevented from getting into the dispenser, as is further described in greater detail in U.S. Provisional Patent Application No. 61/615,709, entitled, “Closure/Connectors for Liner-Based Shipping and Dispensing Containers,” filed Mar. 26, 2012, which is hereby incorporated herein by reference in its entirety. The breakseal may be pierced, removed, punctured, or the like in order to access the contents of the liner and overpack system. In some embodiments, the dispense connector may pierce or puncture the breakseal as the dispense connector is operably coupled with the cap/closure 1002, 1004.

In still further embodiments, the cap/closure 1002, 1004 may include misconnect prevention means 1010. The misconnect prevention means 1010 may be similar to those provided with the misconnect prevention caps/closures of ATMI of Danbury, Conn., or those disclosed in U.S. Pat. No. 5,875,921, titled “Liquid Chemical Dispensing System with Sensor,” issued Mar. 2, 199; U.S. Pat. No. 6,015,068, titled “Liquid Chemical Dispensing System with a Key Code Ring for Connecting the Proper Chemical to the Proper Attachment,” issued Jan. 18, 2000; U.S. Pat. No. 6,879,876, titled “Liquid Handling System with Electronic Information Storage,” issued Apr. 12, 2005; U.S. Pat. No. 7,747,344, titled “Liquid Handling System with Electronic Information Storage,” issued Jun. 29, 2010; U.S. Pat. No. 7,702,418, titled “Secure Reader System,” issued Apr. 20, 2010; U.S. Patent Application No. 60/813,083 filed on Jun. 13, 2006; U.S. Patent Application No. 60/829,623 filed on Oct. 16, 2006; and U.S. patent application Ser. No. 60/887,194 filed on Jan. 30, 2007, each of which is hereby incorporated by reference in its entirety. The misconnect prevention means 1010 of the cap/closure 1002, 1004 may comprise punched key codes, one or more RFID (Radio Frequency Identification) chips, one or more sensors, such as magnetic sensors, or any other suitable mechanism or combination of mechanisms that may be used to prevent misconnection between a dispense connector and the various embodiments of caps/closures described herein.

Further embodiments of caps and/or closures that may be used with embodiments of the present disclosure are those closure/connectors described in U.S. Provisional Patent Appln. No. 61/561,493, entitled, “Closure/Connectors for Liner-Based Shipping and Dispensing Containers,” filed Nov. 18, 2011, which is hereby incorporated by reference herein in its entirety. In some embodiments, the closure/connector may be a high-flow connector that allows for a generally high rate of dispensability, and in some cases, such a closure/connector may also include misconnect prevention features, such as those described above and in more detail in U.S. patent application Ser. No. 12/982,160, entitled, “Closure/Connectors for Liner-Based Dispense Containers,” filed Dec. 30, 2010, and International Patent Application No. PCT/US11/56291, entitled, “Connectors for Liner-Based Dispense Containers,” filed Oct. 14, 2011, both of which are hereby incorporated by reference herein in their entirety. In other embodiments, the closure/connector or any cap/closure disclosed herein may include a head space venting port, that may allow headspace to be removed from the dispenser. Generally, the expression “headspace,” as used herein, may refer to the gas space in the liner that may rise to the top of the liner, above the contents stored in the liner. If all, or substantially all, of the headspace gas is removed, then generally the only remaining sources of gas bubbles, if any, would be from any folds in the liner.

Depending on the type of connector that may be coupled to a liner-based system of the present disclosure, the act of connecting the connector to the liner and/or overpack may exert additional force and/or stress thereon. In order to ensure that the liner and/or dispenser maintains its structural integrity during the connecting process, the liner and/or overpack may include features that add strength to the dispenser. In some embodiments, the features may provide strength to the dispenser in the vertical direction, examples of such features include, but are not limited to vertical sections such as columns on the dispenser where the material of the liner and/or dispenser comprising the vertical sections may be thicker; or vertical columns may be adhered or otherwise affixed to the body of the liner and/or overpack. Such columns can be made from the same material as the liner and/or overpack, or from any other suitable material or combination of materials. Other features for providing strength to the liner and/or overpack are also contemplated and within the spirit of the present disclosure.

To aid in dispense, such as but not limited to, in pump dispense applications, any of the liner-based systems of the present disclosure may include an embodiment that has a dip tube extending any suitable distance into the liner. In other embodiments, the liner-based systems of the present disclosure may not include a dip tube, such as for some pressure dispense or inverted dispense applications. In alternative embodiments, each embodiment of a potentially self-supporting liner described herein, may be shipped without an overpack and placed in a pressurizing vessel at the receiving facility in order to dispense the contents of the liner.

The use of indirect pressure dispense may be advantageous over other dispense methods in some cases. For example, the use of pumps to dispense the contents of a liner can disadvantageously cause bubbling and/or may put stress on the material and the system, which may be undesirable because the purity of the contents of the liner may be crucial. Further, in some cases, a higher rate of dispense may be achieved by pressure dispense as opposed to pump dispense. Direct pressure dispense methods, however, can cause gas to be introduced directly into the contents of the liner and can reduce the purity of the contents of the liner. The use of indirect pressure dispense may help avoid or eliminate these problems. As discussed above, the storage and dispense systems of the present disclosure also permit indirect pressure dispense for a variety of delivery applications for which indirect pressure dispense was traditionally unavailable, and can reduce defects and yield losses associated with traditional pump and vacuum delivery systems.

In some embodiments, the dispense connector features may allow for dispense using existing dispense systems, such as existing indirect pressure dispense systems. Generally, such indirect pressure dispense connector features may include a pressurizing gas inlet that generally permits a gas pressure in-line to be inserted through or coupled with the dispense connector and be in fluid communication with the annular space between the liner and the overpack. In such a system, a pressurizing fluid, gas, or other suitable substance may be introduced into the annular space, causing the liner to collapse away from the overpack wall, thereby pushing the contents of the liner out through a liquid outlet. In one embodiment, for example, to dispense liquid stored in the liner, the annular space between the liner and the overpack may be pressurized, as is further described in International Patent Application No. PCT/US2011/055558, filed Oct. 10, 2011 entitled, “Substantially Rigid Collapsible Liner, Container and/or Liner for Replacing Glass Bottles, and Enhanced Flexible Liners,” which was previously incorporated herein in its entirety.

Embodiments of liners of the present disclosure, in some cases, may be dispensed at pressures less than about 100 psi, or more preferably at pressures less than about 50 psi, and still more preferably at pressures less than about 20 psi. In some cases, the contents of the liners of some embodiments, however, may be dispensed at significantly lower pressures, as may be desirable, depending on the intended use or application involved.

In some embodiments, an overpack and liner system of the present disclosure may also be utilized as a degasser, in order to obtain or provide a degassed liquid product. In particular, the liner could be filled with a helium degassed liquid. The remaining space within the liner could be filled, or “topped off,” with, for example, nitrogen. The liquid will tend to equilibriate with the nitrogen in the headspace, but will generally remain less than 50% saturated. Where a liner for example is comprised of PEN, PEN has a diffusion rate for helium of 0.7.times.10.sup.-13 cm.sup.3 cm/ (cm.sup.2sPa) and a diffusion rate for nitrogen of 0.0004.times.10.sup.-13 cm.sup.3 cm/(cm.sup.2sPa). Accordingly, the helium will diffuse over a period of time, such as a few days, through the PEN liner into the annular space between the liner and overpack, and then diffuse out of the overpack into the external environment. The nitrogen will generally not diffuse through the PEN as quickly, and will tend to remain in the liner for a relatively longer period of time, such as several months or more. Thus, the helium concentration after a relatively short period of time in the liner liquid will be near or at 0, and thus, the liquid will be degassed with respect to the helium. The degassing time will generally depend on a variety of factors, including but not limited to, the ambient temperature, the viscosity of the liner liquid, any vibration of the overpack/liner system, etc. Utilizing the overpack and liner system as a helium degasser in this regard should be less expensive than utilizing a conventional degasser. Of course, hydrogen could similarly be used at potentially lower cost, but could increase the risk for flammability.

In additional embodiments, a dispense assembly, including any cap/closure or connector, may also include control components to control the incoming gas and outgoing liquid. For example, a controller can be operably coupled to control components to control the dispense of the liquid from the liner. One or more transducers may also be included in some embodiments to sense the inlet and/or outlet pressure. In this regard, such control components may be utilized to detect when the liner is near empty. Means for controlling such dispense of fluid from the liner and determining when a liner nears empty are described for example in U.S. Pat. No. 7,172,096, entitled “Liquid Dispensing System,” issued Feb. 6, 2007 and PCT Application Number PCT/US07/70911, entitled “Liquid Dispensing Systems Encompassing Gas Removal,” with an international filing date of Jun. 11, 2007, each of which is hereby incorporated herein by reference in its entirety, and International Patent Application No. PCT/US2011/055558, previously incorporated by reference in its entirety.

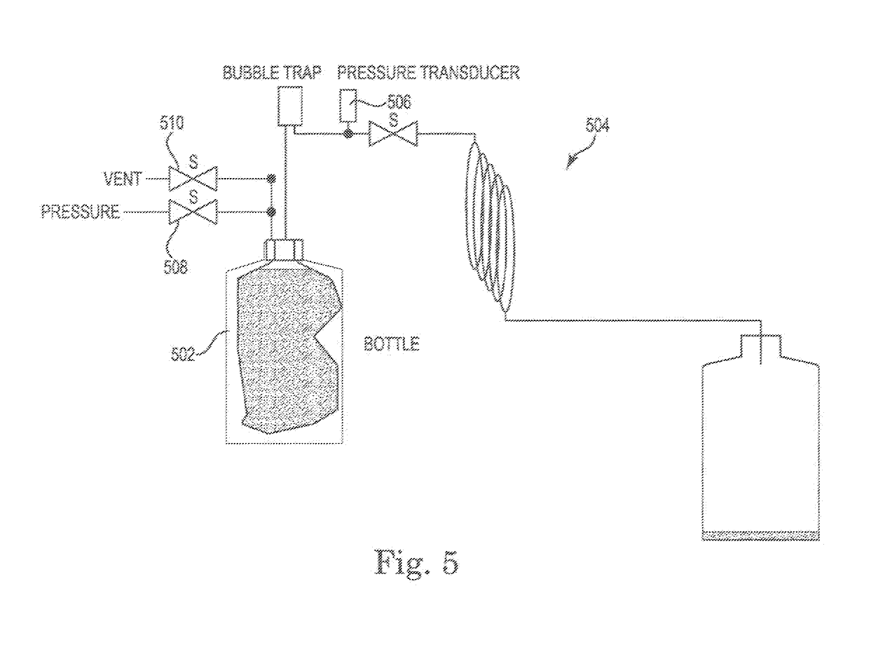

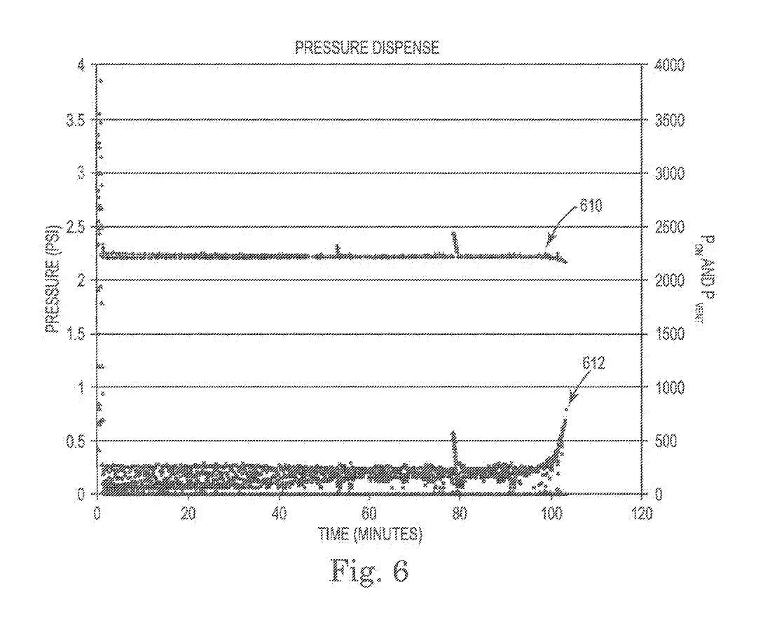

In an additional or alternative embodiment, shown in FIG. 5, an empty detect mechanism may include a liner and overpack system 502 that may be operably connected to an indirect pressure dispensing assembly 504. The dispense assembly 504 may include a pressure transducer or sensor 506, a pressure solenoid or other control valve 508, and a vent solenoid or other control valve 510. A microcontroller may be used to control the pressure solenoid 508 and/or the vent solenoid 510. The outlet liquid pressure may be read and measured by the pressure transducer 506. If the pressure is too low, i.e. lower than a set value, the pressure solenoid 508 may be turned on for a period of time (P.sub.on), thereby causing more pressurizing gas or other substance to be introduced into the annular space between the overpack and liner and raising the outlet liquid pressure. If the pressure is too high, i.e. higher than a predetermined value, the vent solenoid 510 may be turned on for a period of time (P.sub.vent), somewhat relieving the pressure in the annular space between the overpack and liner, and thus the outlet liquid pressure. As may be seen in FIG. 6, as the contents of the liner near empty, the liquid pressure drops 610. The drop in liquid pressure triggers the pressure solenoid to turn on for a longer period of time. The increase in the time that the pressure solenoid is turned on (P.sub.on) rises rapidly as the liner nears empty 612. Accordingly, the amount of time that the pressure valve is on (P.sub.on) may be used to determine when the endpoint of the dispense has been reached.

Alternatively or additionally, the frequency of the on/off switching of the inlet pressure solenoid may be monitored. As indicated above, as the liner approaches empty, the inlet pressure will need to increase in order to maintain the constant liquid outlet pressure. The inlet pressure solenoid may thus switch on/off at a higher frequency as the liner nears empty to permit the required amount of pressurized gas into the annular space between the liner and the container. This frequency of the on/off switching can be a useful empty detect indicator. Empty detect mechanisms such as those disclosed herein, may help save time and energy, and consequently money.

After dispense is completed or substantially completed and the liner is empty or substantially empty, the end-user may dispose of the liner-based system, and/or recycle or reuse some or all of the liner-based system, including some or all of the closure/connector assembly. In order to assist in making the dispensers described herein more sustainable, the dispensers or one or more components thereof, including any overpack, liner(s), handles, etc., may be manufactured from biodegradable materials or biodegradable polymers, including but not limited to: polyhydroxyalkanoates (PHAs), like poly-3-hydroxybutyrate (PHB), polyhydroxyvalerate (PHV), and polyhydroxyhexanoate (PHH); polylactic acid (PLA); polybutylene succinate (PBS); polycaprolactone (PCL); polyanhydrides; polyvinyl alcohol; starch derivatives; cellulose esters, like cellulose acetate and nitrocellulose and their derivatives (celluloid); etc. Similarly, in some embodiments, and if suitable for the industry application, the dispensers or one or more components thereof may be manufactured from materials that can be recycled or recovered, and in some embodiments, used in another process by the same or a different end user, thereby allowing such end user(s) to lessen their impact on the environment or lower their overall emissions. For example, in one embodiment, the dispensers or one or more components thereof may be manufactured from materials that may be incinerated, such that the heat generated therefrom may be captured and incorporated or used in another process by the same or different end user. In general the dispensers or one or more components thereof may be manufactured from materials that can be recycled, or that may be converted into raw materials that may be used again.

In some embodiments, embodiments of the liner-based systems described above may also include features for helping prevent or limit choke-off. Generally speaking, choke-off may be described as what occurs when a liner ultimately collapses on itself, or a structure internal to the liner, to form a choke point disposed above a substantial amount of liquid. When choke-off occurs, it may preclude complete utilization of the liquid disposed within the liner, which can be a significant problem, as many materials used in the biotechnology and/or pharmaceutical industry, for example, can be very expensive. A variety of ways of preventing or handling choke-off are described in PCT Application Number PCT/US08/52506, entitled, “Prevention Of Liner Choke-off In Liner-based Pressure Dispensation System,” with an international filing date of Jan. 30, 2008, which is hereby incorporated herein by reference in its entirety. Additional ways of preventing or handling choke-off are described in International PCT Appl. No. PCT/US11/55558, titled, “Substantially Rigid Collapsible Liner, Container and/or Liner for Replacing Glass Bottles, and Enhanced Flexible Liners,” filed Oct. 10, 2011, which was previously incorporated herein by reference in its entirety.

In some embodiments, the controlled and varied introduction of pressurized gas or liquid into the annular space between the inside of the container wall and the outside of the liner wall may be used to mix the contents of the liner. For example, a controlled cycle of pressurization and depressurization resulting in compression and relaxation of the liner may cause the contents of the liner to mix. In use, this embodiment would allow for the sterile mixing of the contents of the liner without the need for impellers or paddles. Because introducing objects into the interior of the liner may increase the risk of contamination, not needing to introduce impellers or paddles into the liner may advantageously help minimize the risk of contamination.

In some embodiments, the dispensers described herein may include symbols and/or writing that is molded into the dispensers or one or more components thereof. Such symbols and/or writing may include, but is not limited to names, logos, instructions, warnings, etc. Such molding may be done during or after the manufacturing process of the dispensers or one or more components thereof. In one embodiment, such molding may be readily accomplished during the fabrication process by, for example, embossing the mold for the dispensers or one or more components thereof. The molded symbols and/or writing may be used, for example, to differentiate products.

In some embodiments, one or more colors and/or absorbent materials may be added to the materials of the dispensers or one or more components thereof during or after the manufacturing process to help protect the contents of the dispensers from the external environment, to decorate the dispensers, or to use as an indicator or identifier of the contents within the dispensers or otherwise to differentiate multiple dispensers, etc. Colors may be added using, for example, dyes, pigments, nanoparticles, or any other suitable mechanism. Absorbent materials may include materials that absorb ultraviolet light, infrared light, and/or radio frequency signals, etc.

Similarly, in some embodiments, the dispensers or one or more components thereof may be provided with different textures or finishes. As with color and molded symbols and/or writing, the different textures or finishes may be used to differentiate products, to provide an indicator of the contents provided within the dispensers, or to identify for which application or applications the contents are to be used, etc. In one embodiment, the texture or finish may be designed to be a substantially non-slip texture or finish or the like, and including or adding such a texture or finish to the dispensers or one or more components thereof may help improve graspability or handling of the packaging system, and thereby reduce or minimize the risk of dropping of the dispensers. The texture or finish may be readily accomplished during the fabrication process by, for example, providing a mold for the dispensers or one or more components thereof with the appropriate surface features. In other embodiments, the molded dispensers may be coated with the texture or finish. In some embodiments, the texture or finish may be provided on substantially the entire dispenser or substantially the entirety of one or more components thereof. However, in other embodiments, the texture or finish may be provided on only a portion of the dispenser or a portion of one or more components thereof.

Similarly, in some embodiments, the exterior and/or interior walls of the dispensers or one or more components thereof may have any suitable coating provided thereon. The coating may increase material compatibility, decrease permeability, increase strength, increase pinhole resistance, increase stability, provide anti-static capabilities or otherwise reduce static, etc. Such coatings can include coatings of polymers or plastic, metal, glass, adhesives, etc. and may be applied during the manufacturing process by, for example coating a preform used in blow-molding, or may be applied post manufacturing, such as by spraying, dipping, filling, etc.

In some embodiments, the dispensers may include two or more layers, such as an overpack and a liner, multiple overpacks, or multiple liners. In further embodiments, a dispenser may include at least three layers, which may help ensure enhanced containment of the contents therein, increase structural strength, and/or decrease permeability, etc. Any of the layers may be made from the same or different materials, such as but not limited to, the materials previously discussed herein.

In some embodiments, structural features may be designed into the dispensers that add strength and integrity to the dispensers or one or more components thereof. For example, the base (or chime in some embodiments), top, and sides of the dispensers may all be areas that experience increased shake and external forces during filling, transportation, installation, and use (e.g., dispensing). Accordingly, in one embodiment, added thickness or structural edifices (e.g., bridge trestle design) may be added to support stressed regions of the dispensers, which can add strength and integrity to the dispensers. Furthermore, any connection region in the dispensers may also experience increased stress during use. Accordingly, any of these regions may include structural features that add strength through, for example, increased thickness and/or specifically tailored designs. In further embodiments, the use of triangular shapes could be used to add increased strength to any of the above described structures; however, other designs or mechanical support features may be used. In some embodiments, the dispenser may have sufficient strength and durability to withstand a one meter cold drop, for example, without failure. In other cases, the strength and durability of the dispenser may be greater or less, as desired.

Not only may the dispenser itself include structural or other features to provide or enhance the strength of the system, but other elements of the system may also include structural features to provide or enhance the strength thereof. For example, in some embodiments, the cap and/or connectors may also include features to impart added strength to the system. In some cases, the caps and/or connectors may have sufficient durability and strength to withstand a one meter cold drop, for example, without failure and still be able to functionally connect to, or couple with a desired connector or cap, for example. In other cases, the strength and durability of the dispenser may be greater or less, as desired.

In some embodiments, the dispensers or one or more components thereof, including any overpack or liner(s), may include reinforcement features, such as but not limited to, a mesh, fiber(s), epoxy, or resin, etc. that may be integrated or added to the dispensers or one or more components thereof, or portions thereof, in order to add reinforcement or strength. Such reinforcement may assist in high pressure dispense applications, or in applications for dispensing high viscosity contents or corrosive contents.

In some embodiments, the dispensers may include level sensing features or sensors. Such level sensing features or sensors may use visual, electronic, ultrasonic, or other suitable mechanisms for identifying, indicating, or determining the level of the contents stored in the dispensers. For example, in one embodiment, the dispensers or a portion thereof may be made from a substantially translucent or transparent material that may be used to view the level of the contents stored therein.

In further embodiments, flow metering technology may be integrated into or operably coupled with the connectors for a direct measurement of material being delivered from the packaging system to a downstream process. A direct measurement of the material being delivered could provide the end user with data which may help ensure process repeatability or reproducibility. In one embodiment, the flow meter may provide an analog or digital readout of the material flow. The flow meter, or other component of the system, can take the characteristics of the material (including but not limited to viscosity and concentration) and other flow parameters into consideration to provide an accurate flow measurement. Additionally, or alternatively, the flow meter can be configured to work with, and accurately measure, a specific material stored and dispensed from the dispenser. In one embodiment, the inlet pressure can be cycled, or adjusted, to maintain a substantially constant outlet pressure or flow rate.

In additional embodiments, the various embodiments of storage and dispensing systems of the present disclosure may be provided with sensors and/or RFID tags, which may be used to track the assembly, as well as to measure usage, pressure, temperature, excessive shaking, disposition, or any other useful data. The sensors or RFID tags may be active and/or passive. In one embodiment, the sensors or RFID tags may be used to store and track information about a system, including but not limited to, its source or destination, its contents and the source thereof, the total volume, and/or the volume of contents remaining, etc. In other examples, strain gauges may be used to monitor pressure changes of the system. One or more strain gauges may be applied or bonded to any suitable component of the system. The strain gauges may be used to determine pressure build-up in an aging product, but may also be useful for a generally simple measurement of the contents stored in the system. For example, the strain gauges may be used to alert an end user as to any problems with the contents of the system or may be used generally as a control mechanism, such as in applications where the system may be used as a reactor or a disposal system. In embodiments where the sensitivity of the strain gauges is high enough, it may be able to provide a control signal for dispense amount and flow rate.

Some embodiments of the features described above are described in further detail in International PCT Appl. No. PCT/US11/55558, titled, “Substantially Rigid Collapsible Liner, Container and/or Liner for Replacing Glass Bottles, and Enhanced Flexible Liners,” filed Oct. 10, 2011, which was previously incorporated herein by reference in its entirety.

In one particular advantageous embodiment, a storage and dispense system of the present disclosure may include a liner-based system comprising a liner positioned within an overpack, an O-ring for sealing the liner and overpack near the mouths thereof, a base cup, a closure for sealing the liner-based system, and a handle for ease of transport, each of which has been described in various embodiments herein. In one embodiment, the liner may be constructed of a polymer material, the overpack may be constructed of a material comprising PET, the O-ring may be constructed of a material comprising PTFE coated ethylene propylene diene monomer (EPDM), the base cup may be constructed of a material comprising PET, the closure may be constructed of a material comprising PP, and the handle may be constructed of a material comprising LDPE. Of course, any of the other suitable materials described herein may be used for any of the components. The liner and overpack may each be formed by blow molding, such as but not limited to nested co-blow molding or dual blow molding, and may include any of the surface features described herein, such as the panels having a generally rectangular-shaped design, described in detail above. In one embodiment, the liner may be molded to have a wall thickness of about 0.1 mm and the overall wall thickness of the liner and overpack, in one embodiment, may be about 0.3 mm. The liner-based system may be configured to fit the same general form factor or general dimensions as that of a traditional one gallon glass bottle 902 commonly used in critical material delivery applications. A liner-based system made according to these specifications may have a volume of up to and about 4.7 L and an empty weight of about 260-265 g (without the closure). Of course, depending on the selected materials, dimensions, wall thicknesses, and other design choices according to the present disclosure, other embodiments may be characterized by different volumes and weights. The liner-based system may further include UV protectants or UV protectant layers in one or more of the liner, overpack, or base cup. In a particular embodiment, the UV protectants may be selected such that the resulting liner-based system has less than 1%, and preferably less than 0.1%, light transmittance in a wavelength range of about 190-425 nm. A liner-based system made according to these specifications has been tested to have a maximum particle count of 10/ml at less than or equal to 0.15 .mu.m in deionized (DI) water.

While a specific and advantageous embodiment has just been described, the invention disclosed is not so limited, and it is recognized that various features of storage and dispensing systems have been disclosed in various embodiments described herein and may be used in combination with one or more other features described with regard to any of the embodiments. That is, storage and dispensing systems of the present disclosure may include any one or more of the features described herein, whether or not described as the same or another embodiment. For example, any embodiment (unless specifically stated otherwise) may include a stand-alone liner, or a liner and an overpack; may include a flexible liner, semi-rigid, substantially rigid, or rigid collapsible liner; may or may not include a dip tube; may be dispensed by direct or indirect pressure dispense, pump dispense, pressure-assisted pump dispense, inverted dispense, gravity dispense, pressure-assisted gravity dispense, or any other method of dispense; may include any number of layers; may have layers made of the same or different materials; may include a liner made of the same or different material as the overpack; may have any number of surface or structural features; may be filled with any suitable material for any suitable use; may be filled by any suitable means, using any suitable cap or connector; may have one or more barrier coatings; may include a sleeve, chime, or base cup; may include a desiccant; may have one or more methods for reducing choke-off; may be configured for use with any one or more caps, closures, connectors, or connector assemblies as described herein; the material comprising the liner and/or overpack may include one or more additives; the liner and/or overpack may be manufactured by any suitable means or means described herein, including, but not limited to, welding, molding, including blow molding, extrusion blow molding, stretch blow molding, injection blow molding, co-blow molding, and/or dual blow molding; and/or the liners, overpacks, or liner-based systems may have any other combination of features herein described. While some embodiments are particularly described as having one or more features, it will be understood that embodiments that are not described are also contemplated and within the scope of the present disclosure, wherein those embodiments comprise any one or more of the features, aspects, attributes, properties or configurations or any combination thereof of storage and dispense systems described herein.

The various embodiments of storage, shipping, and dispensing systems disclosed herein can provide significant advantages over traditional shipping and dispensing systems, including traditional glass bottles used for critical material delivery applications. For example, the systems disclosed herein may achieve increased dispensability at first bubble detection. Additionally, the systems disclosed have a reduced carbon footprint and can reduce the environmental impact because the overpack is non-hazard and recyclable and the liner may be incinerated. The systems may additionally reduce inventory losses often recognized with traditional pump and vacuum systems. Furthermore, the systems disclosed herein can reduce the cost per liter dispensed as compared to some traditional dispense containers when costs from manufacture through shipping and storage through dispense and disposal are all summed. The systems disclosed herein further increase safety and reduce the risk of accidents and misuse due, at least in part, to the generally unbreakable material of the liner and overpack and misconnect prevention features of the cap, for example. Similarly, the double containment within the liner and the overpack may reduce the risk of vapor release or spillage. Other advantages have been described in, or will be appreciated from, the foregoing description, and those listed here are but a few of the overall advantages the storage, shipping, and dispensing systems of the present disclosure can provide over traditional shipping and dispensing systems.

In the foregoing description various embodiments of the invention have been presented for the purpose of illustration and description. They are not intended to be exhaustive or to limit the invention to the precise faun disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1. (canceled)

2. A method for dual blow molding a liner and overpack, comprising:
molding an inner preform;
molding an outer preform;
heating said inner preform and said outer preform;
inserting said outer preform into a first mold after the step of heating;
blow molding said outer preform after the step of inserting said outer preform to form an overpack;
inserting said inner preform into said overpack; and
blow molding said inner preform within said overpack after the step of inserting said inner preform.

3. The method of claim 2, comprising stretching said outer preform immediately prior to the step of blow molding said outer preform.

4. The method of claim 2, comprising stretching said inner preform immediately prior to the step of blow molding said inner preform.

5. The method of claim 2, comprising removing said overpack from said first mold after the step of blow molding said outer preform.

6. The method of claim 2, wherein said overpack serves as a mold for said inner preform.

7. The method of claim 2, wherein said overpack formed in the step of blow molding said outer preform is absent a bottom vent.

8. The method of claim 2, wherein said inner preform is formed of one of a polyolefin and a polyester.

9. The method of claim 2, wherein said inner preform is formed of polyethylene naphthalate (PEN).

10. The method of claim 2, wherein said inner preform is formed of polyethylene terephthalate (PET).

11. The method of claim 10, wherein said outer preform is formed of PET.
